(19) United States
(12) Patent Application Publication
(10) Pub. No.: US 2015/0215742 A1
(43) Pub. Date: Jul. 30, 2015

(54) MOBILE COMMUNICATION SYSTEM, MOVEMENT PREDICTION DEVICE AND PAGING AREA DETERMINATION METHOD

(71) Applicant: NEC CORPORATION, Minato-ku, Tokyo (JP)

(72) Inventors: Satoshi Ikeda, Tokyo (JP); Nobuharu Kami, Tokyo (JP)

(73) Assignee: NEC Corporation, Tokyo (JP)

(21) Appl. No.: 14/429,831

(22) PCT Filed: May 31, 2013
(86) PCT No.: PCT/JP2013/003465

§ 371 Date: Mar. 20, 2015

(30) Foreign Application Priority Data
Sep. 28, 2012 (JP) 2012-215822

(51) Int. Cl. H04W 4/02; H04W 68/02

(52) U.S. Cl. CPC H04W 4/028; H04W 68/02

(57) ABSTRACT

In related technologies, when a paging request is made immediately after location registration, a larger paging area than necessary is determined. The technologies have also a problem in that a location registration area and a paging area are not determined in an appropriate manner to sufficiently deal with change in the moving characteristic of a mobile station. A mobile communication system (100) according to the present invention comprises: a movement prediction device (40) which predicts a moving state of a mobile station and, on the basis of the prediction result, creates a base station list consisting of base stations each corresponding to a cell having a high possibility of the mobile station's existence within it; and a movement management device (30) which determines a paging area on the basis of the base station list created by the movement prediction device. There, the movement prediction device is configured such that it calculates an estimated location at a predetermined time and a predicted location at a time later than the predetermined time after a movement, and using the estimated location and the predicted location, creates the base station list, assuming that a possibility of the mobile station's existence is higher for cells in the vicinities of the path from the estimated location to the predicted location than for cells in other areas.

### TECHNICAL FIELD

The present invention relates to processes of location registration and paging of a mobile station, in a mobile communication system, and in particular, relates to determination of a location registration area and a paging area.

### BACKGROUND ART

In a mobile communication system, the core network needs to be aware of the area in which a mobile station currently exists, in order to realize calling (paging) of the mobile station in a standby state. To realize it, each mobile station performs location registration by which it notifies the core network of an area (location registration area) in which it currently exists. For example, LTE (Long Term Evolution) of the 3GPP manages the location of a mobile station using, as the unit, a set of neighboring cells referred to as a tracking area (TA).

Each tracking area is identified by a tracking area identifier (TAI). By a base station's notifying a mobile station of the tracking area identifier of the tracking area the base station belongs to, the mobile station can recognize the tracking area where it currently exists. The tracking area where a mobile station exists is registered at the core network side by the mobile station's performing location registration (TAU; Tracking Area Update).

On the basis of the registered information, the core network can be aware of the area where the mobile station exists. When downlink data directed to the mobile station in a standby state has arrived, the tracking area registered as above is regarded as the paging area, and every base station included in the paging area transmits a paging signal. Receiving the paging signal directed to itself, the mobile station performs signaling for establishing a communication channel. Data transmission and reception thereby becomes possible, and calling of the mobile station is thus realized.

Hereafter, an area where a mobile station currently exists, which the core network has become aware of through location registration, will be referred to as a location registration area, and an area over which a paging signal is to be transmitted will be referred to as a paging area. In a paging process with respect to a mobile station, it is generally required for every base station belonging to the corresponding location registration area to transmit a paging signal. However, paging processes performed in cells (zones each covered by one base station) other than the one where the target mobile station currently exists results in waste of radio resources. Accordingly, for the purpose of reducing the waste, there has been proposed a method of narrowing down a paging area from a location registration area to an area over which the paging is to be actually performed. For example, Patent Literature 1 (PTL 1) and Patent Literature 2 (PTL 2) each disclose a technology which narrows down a paging area by determining the paging area on the basis of the location registration history of a target mobile station.

PTL 1 selects a paging area in accordance with the moving speed (or acceleration) of the mobile station on the basis of a location registration history of the mobile station obtained by GPS (Global Positioning System). PTL 2 discloses a technology which calculates density distribution of moving distance in a registration interval from the location registration history of a target mobile station obtained through its periodic location registrations, and determines a paging area to be a set of cells contained within a circle having a radius equivalent to a distance which the accumulated density is equal to or smaller than a threshold value. Further, PTL 2 prevents the paging from finally resulting in a failure by expanding the paging area in a stepwise manner if a paging failure occurs.

With respect to signaling in paging, PTL 1 and PTL 2 reduce the signaling cost required for paging, by narrowing the paging area in accordance with the moving speed of a target mobile station on the basis of the location registration history. However, these methods cannot sufficiently utilize the moving characteristic of the mobile station, because they simply determine the paging area on the basis of a moving distance calculated from the location registration history and of a location at which the mobile station performed the last location registration. For example, if the mobile station has continued to move in a constant direction until a certain time, it is considered to be highly possible that the mobile station keeps moving in the same direction also after that time. However, because the related methods determine the paging area to be an area centered at a location where the mobile station performed the last location registration, paging is performed with respect to almost the same number of cells as that of cells in the moving direction even in the area which is opposite to that of the moving direction and accordingly has a low probability of containing the mobile station, and therefore, they have room of improvement.

Further, while PTL 1 determines the radius of a paging area by using a history of periodic location registrations, the determination is based not on the location of the mobile station at the time of the paging request but on a range into which the mobile station highly possibly moves by the time of the next periodic location registration. As a result, if a paging request is made immediately after a location registration, a larger paging area than necessary is determined. Further, a plurality of movement means are used for human movement, such as stop, walk, a car and a train, and a used means changes with time. However, the related methods do not sufficiently take this point into consideration, and accordingly use a movement characteristic averaged over the period in which a location registration history to be used is acquired, and therefore, they cannot deal with change in movement means.

With respect to signaling in a location registration process, the frequency of location registration can be reduced by increasing the location registration area. However, even if such paging area optimization has been performed, when paging failed, it becomes necessary to perform the paging again by resetting the paging area to be the location registration area, and therefore, simply increasing the location registration area is not desirable. For this reason, it is desirable to design a location registration area in a manner to reduce the frequency of location registration while suppressing increase in the size of the location registration area. PTL 1 and PTL 2 use RAI (route selection area identification information)/LAI (location (registration) area identification information) and a tracking area identifier list, respectively, for identifying a location registration area, but they do not mention anything about determination of a location registration area.

### CITATION LIST

### Patent Literature

[PTL 1]: Japanese Patent Publication No. 4532298

[PTL 2]: Japanese Patent Application Laid-Open No. 2011-49616

### SUMMARY OF INVENTION

### Technical Problem

As described above, in the related technologies, when a paging request is made immediately after a location registration, a larger paging area than necessary is determined. They also have a problem in that determination of a location registration area and a paging area is not made in an appropriate manner to sufficiently deal with change in the movement characteristic of a mobile station. Signaling in movement management which the present invention provides includes signaling required for paging of a mobile station and signaling required for a location registration process, which is necessary for a mobile station to perform when it moves outside the current location registration area. The objective of the present invention is to provide a mobile communications system, a movement prediction device and a paging area determination method which are capable of reducing the cost required for signaling in movement management of a mobile station.

### Solution to Problem

A movement prediction device according to one aspect of the present invention predicts the moving state of a mobile station and, on the basis of the prediction result, creates a base station list including base stations each covering a cell having a high possibility of the mobile station's existing within it, for the purpose of determining a paging area. The movement prediction device is configured such that it calculates an estimated location at a predetermined time and a predicted location at a time later than the predetermined time after a movement, and by using the estimated location and the predicted location, creates the base station list assuming that the possibility of the mobile station's existence is higher for the vicinities of the path from the estimated location to the predicted location than for the other areas.

A mobile communication system according to one aspect of the present invention comprises: a movement prediction device which predicts the moving state of a mobile station and, on the basis of the prediction result, creates a base station list including base stations each covering a cell having a high possibility of the mobile station's existing within it; and a movement management device which determines a paging area on the basis of the base station list created by the movement prediction device. There, the movement prediction device is configured such that it calculates an estimated location at a predetermined time and a predicted location at a time later than the predetermined time after a movement, and by using the estimated location and the predicted location, creates the base station list assuming that the possibility of the mobile station's existence is higher for the vicinities of the path from the estimated location to the predicted location than for the other areas.

A paging area determination method according to one aspect of the present invention comprises: calculating an estimated location at a predetermined time and a predicted location at a time later than the predetermined time after a movement; by using the estimated location and the predicted location, creating the base station list including base stations each covering a cell having a high possibility of the mobile station's existing within it, assuming that the possibility of the mobile station's existence is higher for the vicinities of the path from the estimated location to the predicted location than for the other areas; and determining a page area on the basis of the base station list.

### Advantageous Effects of Invention

According to the present invention, a paging area is appropriately selected and prevented from being larger than necessary. It further becomes possible to provide a system which appropriately determines a location registration area and a paging area in a manner to sufficiently deal with change in the movement characteristic of a mobile station.

### BRIEF DESCRIPTION OF DRAWINGS

FIG. 1 a block diagram showing an example of a configuration in an exemplary embodiment 1.

FIG. 2 a block diagram showing an example of a configuration of a movement prediction device in the exemplary embodiment 1.

FIG. 3 a sequence diagram showing an example of operation of a location registration process in the exemplary embodiment 1.

FIG. 4 a sequence diagram showing an example of operation of a paging process in the exemplary embodiment 1.

FIG. 5 an example of creation of a base station list in the exemplary embodiment 1.

FIG. 6 a sequence diagram showing an example of operation of a location notification process in an exemplary embodiment 2.

FIG. 7 a block diagram showing an example of a configuration of a movement prediction device in an exemplary embodiment 3.

### DESCRIPTION OF EMBODIMENTS

Next, exemplary embodiments of the present invention will be described in detail with reference to drawings.

### Exemplary Embodiment 1

[Description of Configuration]

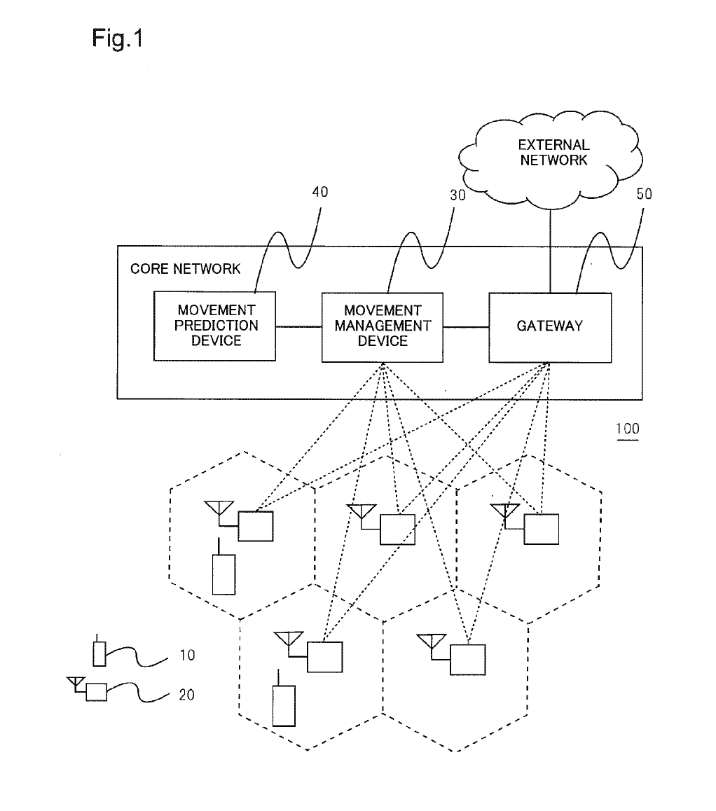

FIG. 1 is a block diagram showing an example of a configuration of a mobile communication system in the present invention. As shown in FIG. 1, the mobile communication system in the present exemplary embodiment comprises a plurality of mobile stations 10, a plurality of base stations 20, a movement management device 30, a movement prediction device 40 and a gateway 50.

Each of the mobile stations 10 performs location registration into the movement management device 30 via one of the base stations 20 in whose cell the mobile station 10 currently exists. The mobile stations 10 each hold information on its location registration area which is notified from the movement management device 30 as a result of the location registration. When any one of the mobile stations 10 has moved into the cell of a base station 10 not included in the location registration area information it holds, it performs location registration. Each of the base stations 20 is connected, by wireless access technology, with mobile stations 10 existing within a range (cell) where wireless signals can reach.

The movement management device 30 performs location management of the mobile stations 10. Here, the location management includes management of location registration areas of the mobile stations 10 and a paging process with respect to the mobile stations 10. The movement management device 30 is connected with the base stations 20, performs processing of location registrations from the mobile stations 10 and manages location registration areas of the mobile stations 10. When a request for connection to one of the mobile stations 10 has been received from an external network, the movement management device 30 performs a paging process with respect to the mobile station 10 in a standby state, in response to a corresponding request from the gateway 50. The movement management device 30 is connected also with the movement prediction device 40, and notifies the movement prediction device 40 of information on the base station in whose cell the mobile station 10 currently exists or location information on the mobile station 10.

The movement management device 30 further has a function of requesting the movement prediction device 40 to estimate an area in which the current location of the mobile station 10 or its location at a time later by a predetermined time period is highly possibly contained, and on the basis of the result, determining a location registration area and a paging area. The movement management device 30 creates a base station list in a manner to include a larger number of base stations in a predicted moving direction of the mobile station than that in the direction opposite to the predicted moving direction. The movement prediction device 40 predicts movement of the mobile station 10 on the basis of information on a location where the mobile station 10 exists, which is obtained through the location information notification received from the movement management device 30.

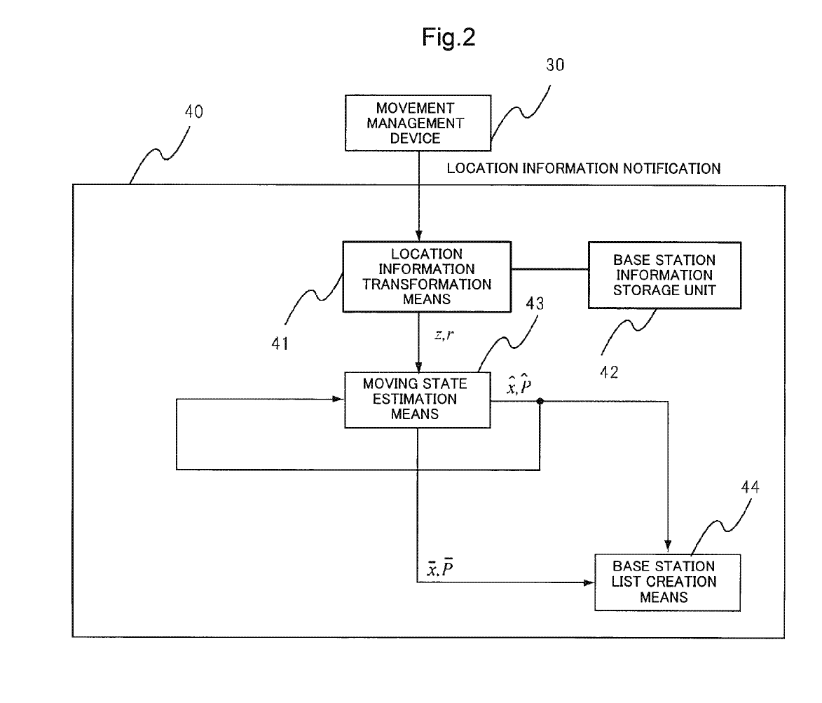

FIG. 2 is a block diagram showing an example of such a configuration as described above. The movement prediction device 40 comprises a location information transformation means 41, a base station information storage unit 42, a moving state estimation means 43 and a base station list creation means 44. As shown in table 1, the base station information storage unit 42 holds correspondence relationships of base station identifiers to installation locations of the respective base stations (or central locations of the respective cells) and to the respective cell radii.

TABLE 1

| Base Station | Location | Cell |
|---|---|---|
| Identifier | (center of cell) | Radius |
| BS ID1 | 35.68, 139.76 | 2 km |
| BS ID2 | 35.70, 139.75 | 4 km |

When a location information notification from the movement management device 30 is given in the form of the base station identifier, the location information transformation means 41 refers to the base station information storage unit 42 and thereby transforms the corresponding base station location and cell radius into an observed location z and an error radius r, and outputs the result to the moving state estimation means 43.

When a location information notification is given in a form including an observed location z and an error radius, which are obtained by GPS or the like, the location information transformation means 41 outputs the information, as it is, to the moving state estimation means 43. Assuming an input time of z and r to be t0, the moving state estimation means 43 is provided with a function to estimate a moving state x̂ of the corresponding mobile station 10 at the time t0 and its error covariance matrix P̂, and also a function to predict a moving state x at a time t0+Δt and its error covariance matrix P .

From x̂, P̂, x and P , the base station list creation unit 44 creates a base station list consisting of a plurality of base station identifiers, which is to be used for creating a location registration area and a paging area. As the moving state estimation means 43, the Karman filter can be used, for example. The gateway 50 relays data communication between the mobile stations 10 and external networks. On receiving incoming data directed to a mobile station 10 in a standby state from an external network, the gateway 50 requests the movement management device 30 to perform paging of the mobile station 10.

[Description of Operation]

Next, a detail description will be given of processing operation performed in exemplary embodiments of the present invention.

(Location Registration)

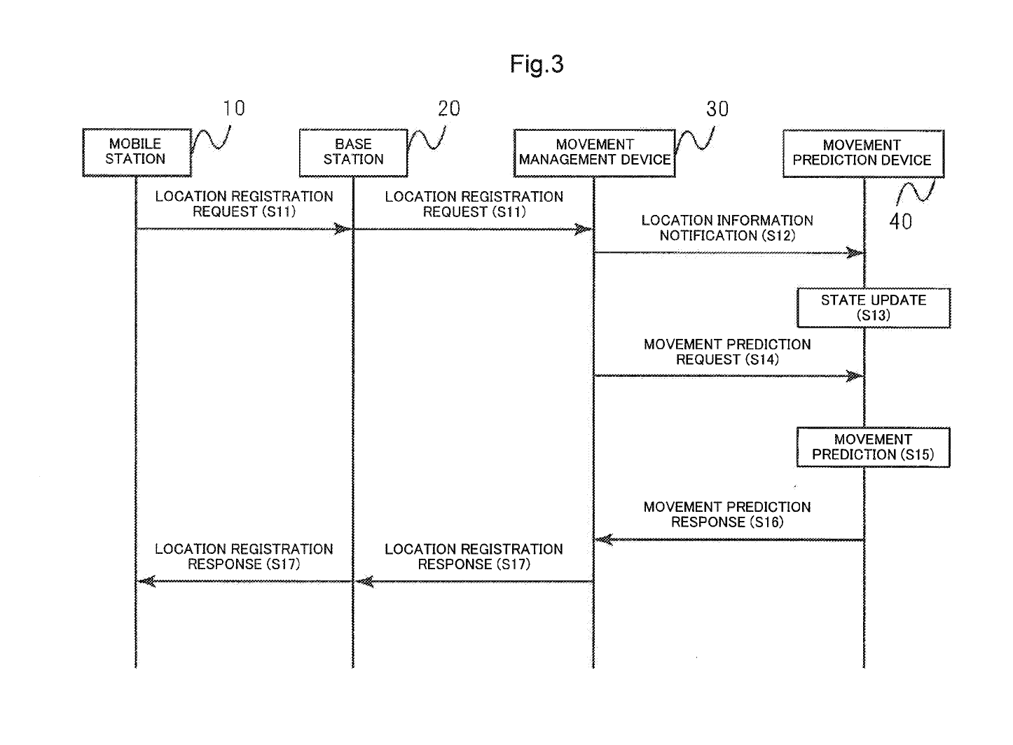

FIG. 3 is a sequence diagram showing an example of operation of a location registration process in the present exemplary embodiment. If detecting itself existing in a cell outside its current location registration area, the mobile station 10 sends a location registration request to the movement management device 30. The location registration request arrives at the movement management device 30 via the base station 20 of the cell in which the mobile station 10 currently exists (S11). The location registration request may include, in addition to information for identifying the mobile station and the base station, coordinate information consisting of the latitude and longitude of the mobile station 10, which are obtained by means of GPS (Global Positioning System) or the like, and their measurement accuracy.

Receiving the location registration request, the movement management device 30 notifies the movement prediction device 40 of location information on the mobile station (S12). Here, the location information may be the identifier of the base station 20 having relayed the location registration request, or may be the coordinate information and its measurement error radius included in the location registration request.

The movement prediction device 40 having received the location information notification updates the moving state of the mobile station 10 on the basis of the location information included in the location information notification (S13). At that time, when the location information is given in a form consisting of the coordinate information and the measurement error radius, the update is performed using the values. When the location information is given in the form of the identifier of the base station 20, the central location of the cell of the base station 20 (or the installation location of the base station) and the cell radius (multiplied by a certain coefficient) are used for the update.

A specific procedure of the moving state update will be described later. The movement management device 30 having sent the location information notification subsequently requests the movement prediction device 40 for movement prediction of the mobile station 10 (S14). Receiving the movement prediction request, the movement prediction device 40 creates an identifier list of base stations whose cells have a high possibility of the mobile station 10 existing within them during a time period from the present to a time later by a time difference s (S15), and sends the identifier list to the movement management device 30 (S16). Receiving the base station identifier list as a movement prediction result, the movement management device 30 registers the received base station list as the location registration area of the mobile station 10 and sends the location registration area to the mobile station 10 via the base station 20 (S17). The mobile station 10 holds the received location registration area as its own location registration area.

(Paging)

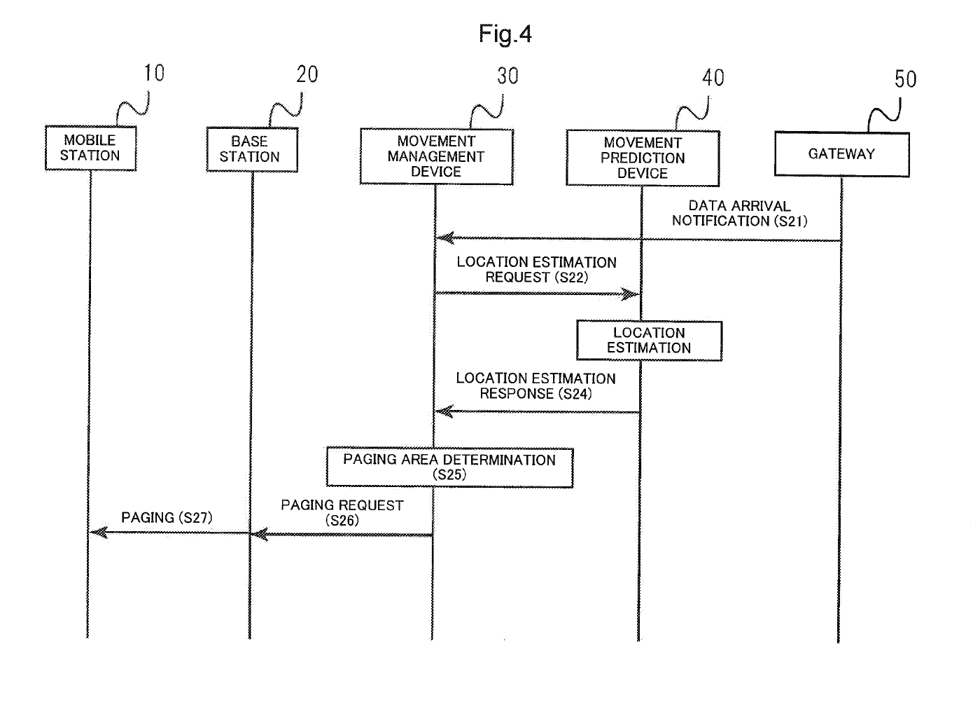

FIG. 4 is a sequence diagram showing an example of operation of a paging process in the present exemplary embodiment. At a time when incoming data directed to the mobile station 10 in a standby state has arrived at the gateway 50 from an external network, there is no communication channel already established between the gateway 50 and the mobile station 10. Accordingly, in order to trigger a paging process, the gateway 50 notifies the movement management device 30 of the data arrival (S21).

The movement management device 30 having received the data arrival notification requests the movement prediction device 40 to estimate an area where the mobile station 10 currently exists (S22). The movement prediction device 40 having received the estimation request creates, from the moving state of the mobile station 10, a base station list consisting of base stations of cells having a high possibility of the mobile station 10 currently existing within them (S23), and sends the base station list to the movement management device 30 (S24). The movement management device 30 determines a paging area to be a base station list obtained as a portion common to the base station list obtained as the location estimation result and the location registration area of the mobile station 10 (S25), and asks the corresponding base stations to transmit a paging signal (S26 and S27).

(Movement Prediction and Location Estimation)

For movement prediction and location estimation performed by the moving state estimation means 43 in the movement prediction device 40, the Kalman filter can be used. The Kalman filter is a method for estimating a current state of a time-varying system from discrete observations of the system including an error. The Kalman filter can estimate a variable's value with the highest certainty by taking a weighted average of the variable's values predicted by a model and actually observed values. Using the Kalman filter, feedback control from observed data to the system becomes possible. Hereinafter, a description will be given of operation of movement prediction and location estimation where the Kalman filter is used. Here, in the present application of the Kalman filter, it is assumed that movement of a mobile station 10 is modeled by the following linear equations.

[equations 1]

x(t)=F(Δt)x(t−Δt)+w(w˜N(0, Q(Δt)))

y(t)=Hx(t)+v(v˜N(0,R(r))) (1)

The equation on the upper line is a state equation expressing a state of the system. The equation on the lower line is a measurement equation expressing a relationship between a variable of the system and an observed variable. The w and v are terms representing disturbance or a measurement error. F and H are matrices for correlating between the variables on the right and left sides.

The x(t) and y(t) are vectors representing, respectively, the moving state of the mobile station and the observed value, both at a time t. F(Δt) and Q(Δt) are, respectively, a matrix representing a temporal transition and a variance-covariance matrix of noise (process noise) of the time transition, both determined by a time difference Δt. As the moving state x(t), a vector consisting of four values, which are respectively of latitude, longitude, the speed in the latitudinal direction and the speed in the longitudinal direction, may be used.

It is desirable for the moving state x(t) to hold information on the location, speed and moving direction of the mobile station. It is assumed that the observed state y(t) is a vector representing the location of the mobile station consisting of latitude and longitude values. F(Δt) and Q(Δt) can be used to model, respectively, constant-velocity linear movement of the mobile station and random acceleration or movement of the mobile station. H is a matrix for observing location information (latitude and longitude) on the mobile station from x(t), and R(r) is a variance-covariance matrix of the observation error determined by a distance r. As R(r), a product of a 2×2 matrix having r squared as the diagonal components and a certain constant can be used, for example.

When an estimated value x̂ of the moving state at a time t0-Δt and its error covariance matrix P̂ have been obtained, the Kalman filter can predict a moving state x at the time t0 and its error covariance matrix P , using the following equations (prediction procedure).

[equations 2]

x̅=F(Δt)·\hat{x}

P̅=F(Δt)·\hat{P}·F(Δt)^{T}+Q(Δt) (2)

Further, when location information z at the time t0 and its error radius information r have been obtained, a moving state at the time t0 and its error covariance matrix can be estimated by the following equations

(update procedure).

[equations 3]

S=H P̅H^{T}+R(r)

K= P̅H^{T}S⁻¹

\hat{x}= x̅+K(z—H· x̅)

\hat{P}(I—KH) P̅ (b 3)

When location notification with respect to the mobile station 10 has been sent from the movement management device 30 to the movement prediction device 40, update of the Kalman filter is performed as follows, as moving state update.

First, a time difference Δt from the previous location notification is calculated. Subsequently performed is a procedure of predicting a moving state at a time which is later by Δt than the time of the previous location notification (that is, the current time). Then, a procedure of updating the moving state is performed using the current observed location z and the observation error radius r included in the location notification. Specifically, the update procedure is performed by assuming the location of the base station 20 identified by the base station identifier (or the central location of the corresponding cell) to be the observed location and the radius of its covering area to be r. When coordinate information and its measurement error radius are included in the location notification, the update procedure may be performed by assuming the coordinate information to be the observed location z and the measurement error radius to be r. As a result of the update procedure, the obtained moving state x̂, its error covariance matrix P̂ and the update time t0 are held, as the moving state, in the movement prediction device 40.

A description will be given below of operation of the movement prediction in the case where, as shown in FIG. 3, the movement prediction device 40 has received a request for movement prediction of the mobile station 10 from the movement management device 30. Here, it is assumed that the movement prediction device 40 has received location notification with respect to the mobile station 10 at the time t0 and has performed the most recent moving state update. That is, the movement prediction device 40 holds a time of state update t0, a moving state x̂ and an error covariance matrix P̂ for each of the mobile stations 10. The movement prediction device 40 having received the request for movement prediction predicts an estimated moving state at a time later by a preset time difference s and a variance-covariance matrix P of its error x , using the prediction procedure of the Kalman filter.

From x̂, P̂, x x̅ and P , the base station list creation means creates a base station list. It calculates, by the following equations, an estimated location ŷ at the time t0 and a covariance matrix of its error Ŝ, and also calculates an estimated location y at the time t0+s and a covariance matrix of its error S .

[equations 4]

\hat{y}=H·\hat{x},\hat{S}=H\hat{P}H^{T}

y̅=H· x̅, S̅=H P̅H^{T} (4)

Here, the combination (ŷ, Ŝ) represents the estimated location of the mobile station 10 at the time t0 and its estimation error, and the combination (y , S ) represents the predicted location of the mobile station 10 at the time t0+s and its prediction error. That is, the two combinations correspond to two-dimensional normal distributions which the estimated and predicted locations respectively follow. In that case, a p_curr1% confidence interval of the estimated location and a p_pred % confidence interval of the predicted locatio correspond to, respectively, an oval O_curr and an oval O_pred on the latitude-longitude coordinates. Using these ovals O_curr and O_pred, the present exemplary embodiment determines base stations of cells having a high possibility of the target mobile station's existence within them, .

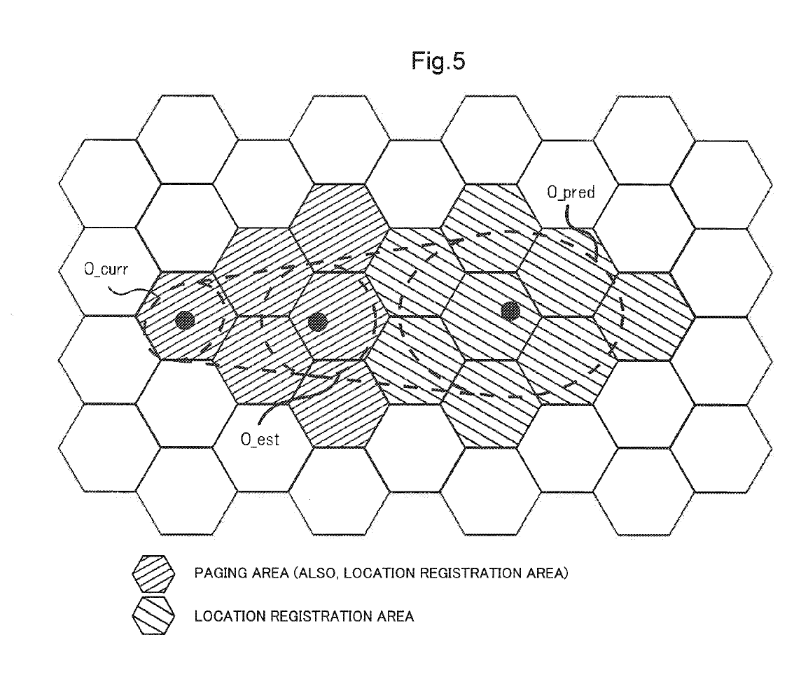

Specifically, as shown in FIG. 5, base stations installed in cells contained in or overlapping with an area constituted by the ovals O_curr and O_pred and tangent lines common to the two ovals are regarded as base stations whose cells have a high possibility of the target mobile station's existence within them. Here, if the two ovals have no common tangent lines, base stations each corresponding to a cell contained in or overlapping with O_pred are used. The movement prediction device 40 sends an identifier list of such base stations with a high possibility of the mobile station's existence within their corresponding cells, to the movement management device 30.

Here, the identifier list may be created in a manner where a target value B of the number of base stations is determined, and then the time difference s and the confidence interval parameters p_curr l and p_pred may be dynamically selected such that the number of base stations to be listed does not exceed (or becomes close to) B. Further, instead of the common tangent lines of the ovals, an envelope of the oval O_pred generated by varying the time difference from zero to s may be used. As a result of the procedure, as shown in FIG. 5, the base station list is created such that a larger number of base stations are included in the predicted moving direction of the mobile station than in the direction opposite to the predicted moving direction.

Also when the movement prediction device 40 has received a request for location estimation of the mobile station 10 from the movement management device 30, as shown in FIG. 4, the prediction procedure of the Kalman filter is used similarly to the case of movement prediction. It is assumed, similarly to in the case of movement prediction, that the movement prediction device 40 has performed the most recent moving state update at the time t0 and has received the location estimation request at a time t1. In that state, similarly to in the movement prediction, an estimated location ŷ at the time t0 and its error covariance matrix Ŝ are calculated first. Further, setting the time difference Δt to be t1-t0, a moving state x at the current time t1 and its error covariance matrix P are calculated by the prediction procedure of the Kalman filter. Then, an estimated current location y and its error covariance matrix S are calculated by the equations 2.

To create a base station list from ŷ, Ŝ, y and S obtained by the above steps, a procedure similar to that of the movement prediction is taken. Specifically, as shown in FIG. 5, created is a base station list consisting of base stations installed in cells which are contained in or sharing a common partial area with an area constituted by an oval O_curr obtained as the p_curr2% confidence interval of the two-dimensional normal distribution represented by (ŷ, S )an oval O_est obtained as the p_est % confidence interval of the two-dimensional normal distribution represented by (y , S ) and the tangent lines common to the two ovals, and the created base station list is sent to the movement management device 30. At that time, in order to prevent paging failure, it is desired to set p_curr2 and p_est at larger values than those of p_curr1 and p_pred, respectively.

Alternatively, a base station list simply consisting of base stations installed in cells which are contained in or sharing a common partial area with the oval O_est may be used. In the present exemplary embodiment, the descriptions have been given of the configuration in which the Kalman filter is used for the movement prediction and location estimation. However, the movement prediction means is not limited to the described one, but any other method may be used, not limiting to the Kalman filter, as long as the method is a moving state estimation means which can calculate a predicted value of the location of a mobile station at a certain time and its error covariance matrix on the basis of information on a previous location of the mobile station. For example, other prediction means such as a derivative filter of the Kalman filter and a particle filter may be used.

In the present exemplary embodiment, a location registration area and a paging area are determined by performing movement prediction and location estimation of a target mobile station in accordance with the moving state of the mobile station including its moving speed and moving direction. In particular, a base station list is created in a manner to include a larger number of base stations in the predicted moving direction of the mobile station than in the direction opposite to the predicted moving direction. That is, the determination of a location registration area and a paging area can be performed taking into account the moving direction of the mobile station. Accordingly, even when the number of cells included in the location registration area is set to be comparable to that used in the related methods, time intervals of the location registration become longer, and the number of signals for the location registration can be reduced. Further, the number of paging processes required of base stations located in the direction opposite to the moving direction of the mobile station can be reduced.

### Exemplary Embodiment 2

The objective of the present exemplary embodiment is to increase the accuracy of movement prediction in the mobile communications system according to the exemplary embodiment 1. In a mobile communications system in the present exemplary embodiment, operation of base stations and that of a movement management device are different from those in the exemplary embodiment 1. The base stations 20A and the movement management device 30A in the present exemplary embodiment will be distinguished from those in the exemplary embodiment 1 by assigning them the signs 20A and 30A, respectively, which are different from those in the exemplary embodiment 1. The base stations 20A in the present exemplary embodiment are different from the base station 20 in the exemplary embodiment 1 in that they send a location notification trigger to the movement management device 30A, in addition to the operation of the base station 20.

The location notification trigger is sent from any of the base stations 20 to the movement management device 30A when it has found that a mobile station 10 exists in its own cells. As the location notification trigger, an explicit new message may be defined and then used, or a conventional message sent and received in mobile communication systems may be used. As the conventional message in the present case, it is possible to use, for example, a message to be sent from the base stations 20A to the movement management device 30A, which is included in a signal sequence performed for enabling a mobile station 10 to establish or disconnect a communication channel to the core network or in a signal sequence performed in handover of when a mobile station 10 has moved across base stations.

In a case of LTE, S1-AP: Initial Context Setup Complete (the name of a control protocol for performing communication between the core network and the base stations in a LTE system) in the Service Request procedure, S1-AP: S1 UE Context Release Complete in the S1 Release procedure and Path Switch Request in the X2 based handover may be used. What is important for the location notification trigger is to enable identification of the base station corresponding to a cell in which a mobile station exists, and a message employed as the location notification trigger in the present invention is not limited to the above-described ones.

The movement management device 30A in the present exemplary embodiment, on receiving the location notification trigger from any of the base station 20A, performs location information notification to a movement prediction device 40A, in addition to the operation of the movement management device 30 in the exemplary embodiment 1. In the exemplary embodiment 1, the moving state update performed in the movement prediction device is triggered by a request for location registration of a mobile station. In contrast, in the present exemplary embodiment, a process other than that of location registration also becomes a trigger of the moving state update, as described above.

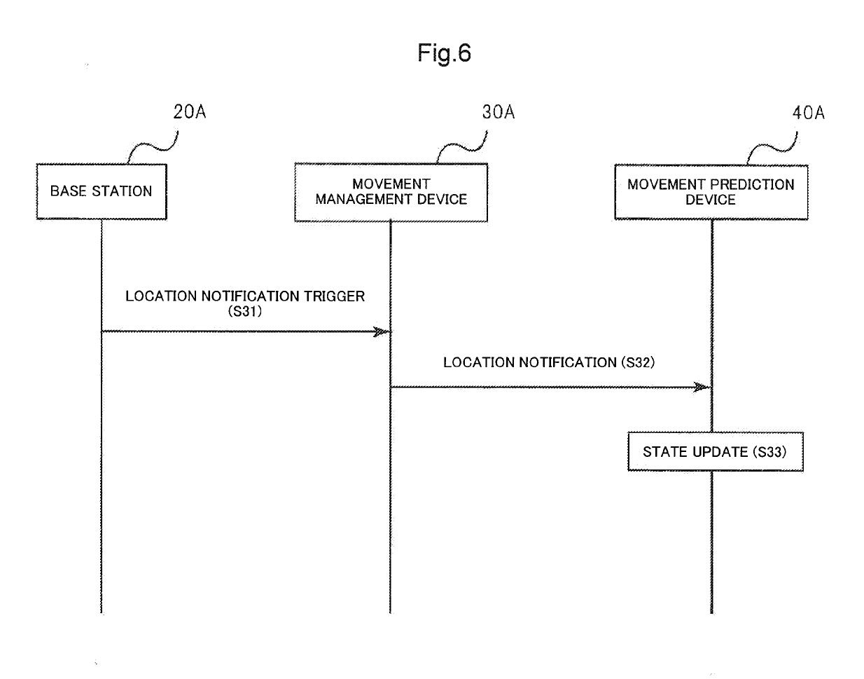

FIG. 6 is a sequence diagram showing an example of operation of the moving state update in the present exemplary embodiment. First, the base station 20A sends a location notification trigger to the movement management device 30A (S31). The movement management device 40A having received the location notification trigger performs location information notification including the identifiers of a target mobile station 10 and a target base station 20A (S32). This process is equivalent to that of S12 in the exemplary embodiment 1. The movement prediction device 40A having received the location information notification performs the moving state update similarly to in S13 of the exemplary embodiment 1 (S33).

Compared to the exemplary embodiment 1, the present exemplary embodiment can perform the moving state update by utilizing information on a cell in which a mobile station exists, which is obtained at a time such as of establishing a communication channel and of handover. That is, the movement state update can be performed at a higher frequency than in the exemplary embodiment 1 where only the location registration process is utilized, and accordingly, more highly accurate movement prediction of a mobile station becomes possible. It makes possible highly accurate determination of a location registration area and a paging area, and as a result, the signaling cost can be reduced.

### Exemplary Embodiment 3

The objective of the present exemplary embodiment is to increase the accuracy of movement prediction, similarly to the exemplary embodiment 2. The present exemplary embodiment is different from the exemplary embodiment 1 in that movement prediction is performed using a plurality of movement models and in the configuration and operation of a movement prediction device. The movement prediction device 40B in the present exemplary embodiment will be distinguished from that in the exemplary embodiment 1 by assigning it the sign 40B, which is different from that used in the exemplary embodiment 1.

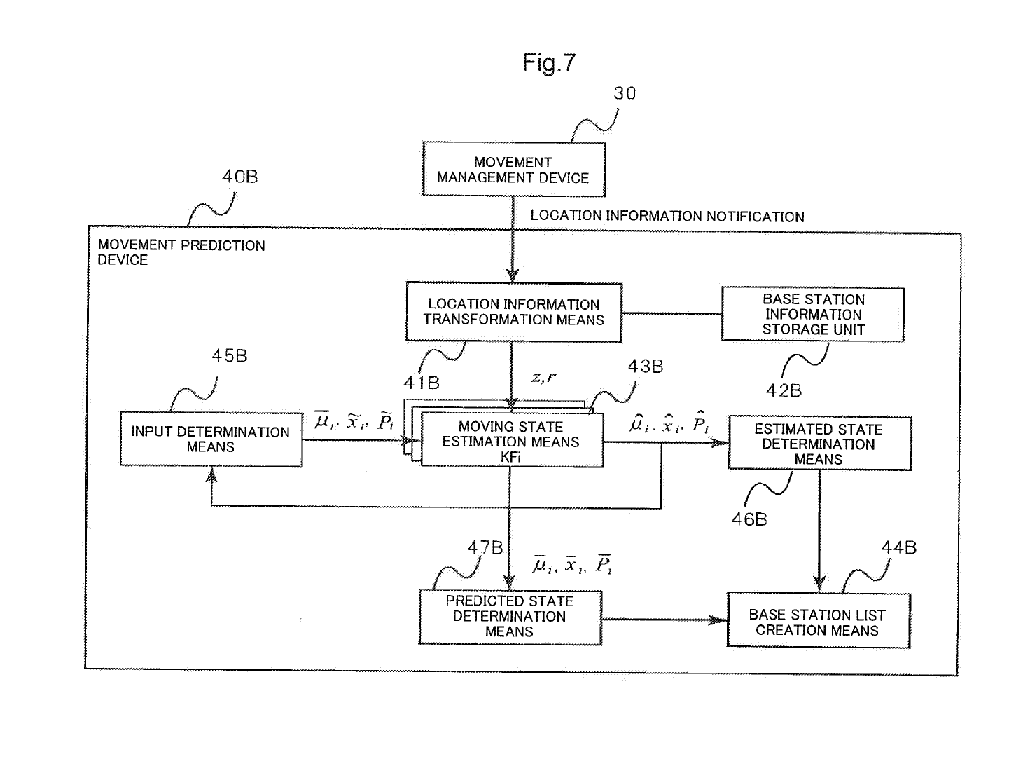

FIG. 7 is a block diagram showing an example of a configuration of the movement prediction device 40B in the present exemplary embodiment. Compared with the movement prediction device 40 in the exemplary embodiment 1, the movement prediction device 40B in the present exemplary embodiment is different in that it comprises a plurality of moving state estimation means KFi (i=1, . . . , N) 43B, an input determination means 45B, an estimated state determination means 46B and a predicted state determination means 47 B

In the present exemplary embodiment, a description will be given of an example of operation where the Kalman filter is used for the moving state estimation means KFi 43B. However, what is required of the moving state estimation means KFi 43B is to be able to estimate and predict the moving state of a mobile station and its error information, and also to quantitatively calculate the plausibility of a movement model, and accordingly, it is not limited to the Kalman filter. KFi is the Kalman filter which performs movement prediction and estimation of a movement model Mi defined by Fi(Δt), Qi(Δt), Hi and Ri(r). The movement model Mi represents a plurality of different movement models, for which a stop model, a random walk model, a uniform-velocity linear movement model and the like are used. Even when using the same type of movement models, by preparing a plurality of models each having different components of Qi(Δt) from those in the other models, it is possible to define movement models each having a different magnitude of speed change from that of the others.

In the present exemplary embodiment, each of the mobile stations 10 is assumed to be in motion in accordance with one of the plurality of movement models at a certain time, and it is considered that, at a time later by a time difference At, a mobile station 10 following a movement model Mi transits to a movement model Mj with a transition probability π(Δt)ij.

Here, triggered by location information notification at a time t0, the moving state estimation means KFi 43B corresponding to the movement model Mi is updated, a moving state xî, its error covariance matrix Pî and a state at the time t0-Δt are estimated, and a weight of the model is calculated to be μî. In that state, prediction and update procedures for each of the Kalman filters KFi at the time t0 are performed by the following steps. First, the input determination means 45B determines a weight μi^{-,}a moving state xi~ and an error covariance matrix Pi~ of the moving state, corresponding to each of the plurality of movement models, by the use of the following equations.

$$\begin{matrix}[ equation s 5 ] & \\ {\overline{μ}}_{i} = {\sum }_{j} {π ( Δ t )}_{j , i} {\hat{μ}}_{j} \\ {\tilde{x}}_{i} = \frac{1}{{\overline{μ}}_{i}} {\sum }_{j} {π ( Δ t )}_{j , i} {\hat{μ}}_{j} {\hat{x}}_{j} \\ {\tilde{P}}_{i} = \frac{1}{{\overline{μ}}_{i}} {\sum }_{j} {π ( Δ t )}_{j , i} {\hat{μ}}_{j} [ {\hat{P}}_{j} + ( {\hat{x}}_{j} - {\tilde{x}}_{i} ) {( {\hat{x}}_{j} - {\tilde{x}}_{i} )}^{T} ] & ( 5 )\end{matrix}$$

Next, taking xi~ and Pi~ as input, the prediction procedure of KFi is performed by the following equations 6, and thereby, a predicted value of the moving state xi~ at the time t0 and its error covariance matrix Pi~ are calculated. Here, Fi(Δt), Qi(Δt) and H in the following equations 5 and 6 are parameters of the movement models, corresponding to F(Δt) and Q(Δt) in the equations 1, to which the subscript i is attached in order to distinguish between the plurality of models, .

[equations 6]

x̅ᵢ=Fᵢ(Δt)\tilde{x}ᵢ

P̅ᵢ=Fᵢ(Δt)\tilde{P}ᵢFᵢ(Δt)^{T}+Qᵢ(Δt) (6)

Finally, taking xi~, Pi~ and an observed value z (and its error radius r) at the time t0 as input, the update procedure of each of the Kalman filters KFi is performed, and thereby, a moving state xî at the time t0 and its covariance matrix Pî are calculated.

$$\begin{matrix}[ equations 7 ] & \\ {S}_{i} = {H}_{i} {\overline{P}}_{i} {H}_{i}^{T} + {R}_{i} ( r ) \\ {K}_{i} = {\overline{P}}_{i} {H}_{i}^{T} {S}_{i}^{- 1} \\ {\hat{x}}_{i} = {\overline{x}}_{i} + {K}_{i} ( z - {H}_{i} {\overline{x}}_{i} ) \\ {\hat{P}}_{i} = ( I - {K}_{i} {H}_{i} ) {\overline{P}}_{i} \\ {\hat{μ}}_{i} = \frac{{\overline{μ}}_{i} \cdot mnvpdf ( z , {S}_{i} )}{{\sum }_{j} {\overline{μ}}_{j} \cdot mnvpdf ( z , {S}_{j} )} & ( 7 )\end{matrix}$$

Here, mnvpdf(z, S) represents a probability density function of multivariate normal distribution with an average z and a variance S.

Integrating the moving state xî with its error covariance matrix Pî, both estimated by KFi, the estimated state determination means 46B determines a final moving state x̂ and its error covariance matrix P̂ by the use of either equations 8 or equations 9.

$$\begin{matrix}[ equations 8 ] & \\ k = arg {max}_{i} ( {\hat{μ}}_{i} ) \\ \hat{x} = {\hat{x}}_{k} \\ \hat{P} = {\hat{P}}_{k} & ( 8 ) \\ [ equations 9 ] & \\ \hat{x} = {\sum }_{i} {\hat{μ}}_{i} {\hat{x}}_{i} \\ \hat{P} = {\sum }_{i} {\hat{μ}}_{i} [ {\hat{P}}_{i} + ( \hat{x} - {\hat{x}}_{i} ) {( \hat{x} - {\hat{x}}_{i} )}^{T} ] & ( 9 )\end{matrix}$$

Here, argmax means an argument of the maximum. It is a value at which the function value is largest. Similarly, Integrating the moving state xi~ with its error covariance matrix Pi , both estimated by KFi, the predicted state determination means 47B determines a final moving state x and its error covariance matrix P by the use of either equations 10 or equations 11

$$\begin{matrix}[ equations 10 ] & \\ k = arg {max}_{i} ( {\overline{μ}}_{i} ) \\ \overline{x} = {\overline{x}}_{k} \\ \overline{P} = {\overline{P}}_{k} & ( 10 ) \\ [ equations 11 ] & \\ \overline{x} = {\sum }_{i} {\overline{μ}}_{i} {\overline{x}}_{i} \\ \overline{P} = {\sum }_{i} {\overline{μ}}_{i} [ {\overline{P}}_{i} + ( \overline{x} - {\overline{x}}_{i} ) {( \overline{x} - {\overline{x}}_{i} )}^{T} ] & ( 11 )\end{matrix}$$

The base station list creation means 44 in the present exemplary embodiment creates a base station list by the process similar to that in the exemplary embodiment 1, using x̂, P̂, x and P .

The present exemplary embodiment performs movement prediction and location estimation by preparing a plurality of movement models, taking transition between them into consideration and giving a higher weight to a movement model fitting more to the movement of the mobile station 10. It makes it possible to perform movement prediction and location estimation which are in accordance with movement mode change between a variety of movement modes such as stop, walk and car. Accordingly, highly accurate determination of a location registration area and a paging area becomes possible, and as a result, the signaling cost can be reduced.

The present invention is not limited to the above-described exemplary embodiments, and therefore can be appropriately changed within a range not departing from the spirit of the present invention. For example, an LTE system has been mentioned in the above-described examples, as a specific example of application of the present invention. However, the present invention may be applied also to another type of wireless communication system, for example, a communication system according to a communication standard of the fourth generation or beyond (e.g. LTE-Advanced, IMT-Advanced and WiMAX2). The above-described processes performed in the movement prediction device 40 and the movement management device 30 can be realized by causing a computer to execute a program.

The present invention has been described as a hardware configuration in the above-mentioned exemplary embodiments, but the present invention is not limited to that way. Any optional process of the present invention can be realized by causing a CPU (Central Processing Unit) to execute a computer program. Here, the program mentioned above may be stored using various types of non-transitory computer readable media, and may be thereby supplied to the computer. The non-transitory computer readable media include various types of tangible storage media. Examples of the non-transitory computer readable media include a magnetic recording medium (for example, a flexible disc, a magnetic tape and a hard disk drive), a magneto-optic recording medium (for example, a magneto-optic disc), a CD-ROM (Read Only Memory), a CD-R, a CD-R/W, a semiconductor memory (for example, a mask ROM, a PROM (Programmable ROM), an EPROM (Erasable PROM), a flash ROM and a RAM (Random Access Memory)). The program may be supplied to the computer also by means of various types of transitory computer readable media. Examples of the transitory computer readable media include an electrical signal, an optical signal and a radio wave. The transitory computer readable media can supply the program to the computer via a wired communication channel of an electric wire, an optic fiber or the like, or a wireless communication channel.

Part or the whole of the exemplary embodiments described above can be described also as, but not limited to, the following supplementary notes.

(Supplementary Note 1)

A movement prediction device for predicting a moving state of a mobile station and, on the basis of the prediction result, creating a base station list consisting of base stations each corresponding to a cell having a high possibility of the mobile station's existence within it, for the purpose of determining a paging area, wherein an estimated location at a predetermined time and a predicted location at a time later than the predetermined time after a movement are calculated, and using the estimated location and the predicted location, the base station list is created assuming that a possibility of the mobile station's existence is higher for cells in the vicinities of the path from the estimated location to the predicted location than for cells in other areas.

(Supplementary Note 2)

The movement prediction device according to supplementary note 1, wherein the base station list is created in a manner to include a larger number of base stations in a predicted moving direction of the mobile station than in the direction opposite to the predicted moving direction.

Supplementary Note 3)

The movement prediction device according to supplementary note 1 or 2, wherein: the estimated location and the predicted location, of the mobile station, each correspond to an oval area; and the base station list for a paging area is created on the basis of base stations each covering a cell contained in or overlapping with an area surrounded by an envelope obtained through the elapse of time from the oval area represented by the estimated location to the oval area represented by the predicted location.

(Supplementary Note 4)

The movement prediction device according to supplementary note 1 or 2, comprising a plurality of moving state estimation means corresponding to a plurality of movement models, wherein the plurality of moving state estimation means estimate the plausibility of movement prediction of the mobile station, on the basis of location information on the mobile station, and each use the estimated location and the predicted location according to one of the plurality of movement models.

(Supplementary Note 5)

The movement prediction device according to supplementary note 1 or 2, comprising a plurality of moving state estimation means corresponding to a plurality of movement models, wherein the plurality of moving state estimation means take values of the plausibility of movement prediction as weights, and thereby create the base station list by using a weighted average of the estimated locations calculated on the basis of the plurality of movement models and a weighted average of the predicted locations calculated on the basis of the plurality of moving state estimation means as, respectively, an estimated location and a predicted location.

(Supplementary Note 6)

A mobile communication system, comprising: a movement prediction device for predicting a moving state of a mobile station and, on the basis of the prediction result, creating a base station list consisting of base stations each corresponding to a cell having a high possibility of the mobile station's existence within it; and a movement management device for determining a paging area on the basis of the base station list created by the movement prediction device, wherein the movement prediction device calculates an estimated location at a predetermined time and a predicted location at a time later than the predetermined time after a movement, and using the estimated location and the predicted location, creates the base station list assuming that a possibility of the mobile station's existence is higher for cells in the vicinities of the path from the estimated location to the predicted location than for cells in other areas.

(Supplementary Note 7)

The mobile communication system according to supplementary note 6, wherein the movement prediction device creates the base station list in a manner to include a larger number of base stations in a predicted moving direction of the mobile station than in the direction opposite to the predicted moving direction.

(Supplementary Note 8)

The mobile communication system according to supplementary note 6 or 7, wherein: the estimated location and the predicted location, of the mobile station, both estimated by the movement prediction device, each correspond to an oval area; and the base station list for a paging area is created on the basis of base stations each covering a cell contained in or overlapping with an area surrounded by an envelope obtained through the elapse of time from the oval area represented by the estimated location to the oval area represented by the predicted location.

(Supplementary Note 9)

The mobile communication system according to supplementary note 6 or 7, wherein: the movement prediction device comprises a plurality of moving state estimation means corresponding to a plurality of movement models; and the plurality of moving state estimation means estimate the plausibility of movement prediction of the mobile station, on the basis of location information on the mobile station, and each use the estimated location and the predicted location according to one of the plurality of movement models.

(Supplementary Note 10)

The mobile communication system according to supplementary note 6 or 7, wherein: the movement prediction device comprises a plurality of moving state estimation means corresponding to a plurality of movement models; and the plurality of moving state estimation means take values of the plausibility of movement prediction as weights, and thereby create the base station list by using a weighted average of the estimated locations calculated on the basis of the plurality of movement models and a weighted average of the predicted locations calculated on the basis of the plurality of moving state estimation means as, respectively, an estimated location and a predicted location.

(Supplementary Note 11)

A paging area determination method, comprising: a step of calculating an estimated location of a mobile station at a predetermined time and a predicted location of the mobile station at a time later than the predetermined time after a movement; a step of, by the use of the estimated location and the predicted location, creating a base station list consisting of base stations each corresponding to a cell having a high possibility of the mobile station's existence within it, assuming that a possibility of the mobile station's existence is higher for cells in the vicinities of the path from the estimated location to the predicted location than for cells in other areas; and a step of determining a paging area on the basis of the base station list.

(Supplementary Note 12)

The paging area determination method according to supplementary note 11, wherein, in the step of creating the base station list, the base station list is created in a manner to include a larger number of base stations in a predicted moving direction of the mobile station than in the direction opposite to the predicted moving direction.

(Supplementary Note 13)

The paging area determination method according to supplementary note 11 or 12, wherein, in the step of creating the base station list: the estimated location and the predicted location, of the mobile station, each correspond to an oval area; and the base station list for a paging area is created on the basis of base stations each covering a cell contained in or overlapping with an area surrounded by an envelope obtained through the elapse of time from the oval area represented by the estimated location to the oval area represented by the predicted location.

(Supplementary Note 14)

The paging area determination method according to supplementary note 11 or 12, wherein, in the step of calculating an estimated location and a predicted location, of the mobile station, with respect to each one of a plurality of movement models: the plausibility of movement prediction is estimated on the basis of location information on the mobile station; and the estimated location and the predicted location according to one of the plurality of movement models are used.

(Supplementary Note 15)

The paging area determination method according to supplementary note 11 or 12, wherein, in the step of calculating an estimated location and a predicted location, of the mobile station, taking values of the plausibility of movement prediction as weights, a weighted average of the estimated locations calculated on the basis of the plurality of movement models and a weighted average of the predicted locations calculated on the basis of the plurality of moving state estimation means are used as, respectively, an estimated location and a predicted location.

(Supplementary Note 16)

A non-transitory computer readable medium for paging area determination process, being a non-transitory computer readable medium for creating a base station list for determining a paging area, which causes a computer to execute: a step of calculating an estimated location of a mobile station at a predetermined time and a predicted location of the mobile station at a time later than the predetermined time after a movement; and a step of, by the use of the estimated location and the predicted location, creating a base station list consisting of base stations each corresponding to a cell having a high possibility of the mobile station's existence within it, assuming that a possibility of the mobile station's existence is higher for cells in the vicinities of the path from the estimated location to the predicted location than for cells in other areas.

(Supplementary Note 17)

The non-transitory computer readable medium for paging area determination process according to supplementary note 16, wherein, in the step of creating the base station list, the base station list is created in a manner to include a larger number of base stations in a predicted moving direction of the mobile station than in the direction opposite to the predicted moving direction.

The present invention has been described above with reference to the exemplary embodiments, but the present invention is not limited by the above descriptions. To the configurations and details of the present invention, various changes which are understandable to those skilled in the art can be made within the scope of the present invention.

This application is based upon and claims the benefit of priority from Japanese Patent Application No. 2012-215822, filed on Sep. 28, 2012, the disclosure of which is incorporated herein in its entirety by reference.

### REFERENCE SIGNS LIST

10 mobile station

20 base station

20A base station

30 movement management device

30A movement management device

40 movement prediction device

40A movement prediction device

40B movement prediction device

41 location information transformation means

41B location information transformation means

42 base station information storage unit

42B base station information storage unit

43 moving state estimation means

43B moving state estimation means

44 base station list creation means

44B base station list creation means

45B input determination means

46B estimated state determination means

47B predicted state determination means

50 gateway

100 mobile communication system

What is claimed is:

1. A movement prediction device: that calculates an estimated location of a mobile station at a predetermined time and a predicted location of the mobile station at a time later than the predetermined time after a movement; and, creates a base station list by the use of the estimated location and the predicted location, assuming that a possibility of the mobile station's existence is higher for cells in the vicinities of the path from the estimated location to the predicted location than for cells in other areas.

2. The movement prediction device according to claim 1, wherein the base station list is created in a manner to include a larger number of base stations in a predicted moving direction of the mobile station than in the direction opposite to the predicted moving direction.

3. The movement prediction device according to claim 1, wherein: the estimated location and the predicted location, of the mobile station, each correspond to an oval area; and the base station list for a paging area is created on the basis of base stations each covering a cell contained in or overlapping with an area surrounded by an envelope obtained through the elapse of time from the oval area represented by the estimated location to the oval area represented by the predicted location.

4. The movement prediction device according to claim 1, comprising a plurality of moving state estimation units that correspond to a plurality of movement models, wherein the plurality of moving state estimation units estimate the plausibility of movement prediction of the mobile station, on the basis of location information on the mobile station, and each use the estimated location and the predicted location according to one of the plurality of movement models.

5. The movement prediction device according to claim 1, comprising a plurality of moving state estimation units that correspond to a plurality of movement models, wherein the plurality of moving state estimation units take values of the plausibility of movement prediction as weights, and thereby create the base station list by using a weighted average of the estimated locations calculated on the basis of the plurality of movement models and a weighted average of the predicted locations calculated on the basis of the plurality of moving state estimation units as, respectively, an estimated location and a predicted location.

6. A mobile communication system, comprising: a movement prediction device that predicts a moving state of a mobile station and, on the basis of the prediction result, creating a base station list consisting of base stations each corresponding to a cell having a high possibility of the mobile station's existence within it; and a movement management device that determines a paging area on the basis of the base station list created by the movement prediction device, wherein the movement prediction device calculates an estimated location at a predetermined time and a predicted location at a time later than the predetermined time after a movement, and using the estimated location and the predicted location, creates the base station list, assuming that a possibility of the mobile station's existence is higher for cells in the vicinities of the path from the estimated location to the predicted location than for cells in other areas.

7. The mobile communication system according to claim 6, wherein the movement prediction device creates the base station list in a manner to include a larger number of base stations in a predicted moving direction of the mobile station than in the direction opposite to the predicted moving direction.

8. The mobile communication system according to claim 6, wherein: the estimated location and the predicted location, of the mobile station, both estimated by the movement prediction device, each correspond to an oval area; and the base station list for a paging area is created on the basis of base stations each covering a cell contained in or overlapping with an area surrounded by an envelope obtained through the elapse of time from the oval area represented by the estimated location to the oval area represented by the predicted location.

9. A paging area determination method, comprising: calculating an estimated location of a mobile station at a predetermined time and a predicted location of the mobile station at a time later than the predetermined time after a movement; by the use of the estimated location and the predicted location, creating a base station list consisting of base stations each corresponding to a cell having a high possibility of the mobile station's existence within it, assuming that a possibility of the mobile station's existence is higher for cells in the vicinities of the path from the estimated location to the predicted location than for cells in other areas; determining a paging area on the basis of the base station list.

10. The paging area determination method according to claim 9, wherein, the base station list is created in a manner to include a larger number of base stations in a predicted moving direction of the mobile station than in the direction opposite to the predicted moving direction.
